(19) United States
(12) Patent Application Publication
(10) Pub. No.: US 2025/0128617 A1
(43) Pub. Date: Apr. 24, 2025

(54) CONTROL DEVICE FOR LOCKING DEVICE

(71) Applicant: TOYOTA JIDOSHA KABUSHIKI KAISHA, Toyota-shi (JP)

(72) Inventor: Daisuke HIROSE, Toyota-shi (JP)

(73) Assignee: TOYOTA JIDOSHA KABUSHIKI KAISHA, Toyota-shi (JP)

(21) Appl. No.: 18/799,280

(22) Filed: Aug. 9, 2024

(30) Foreign Application Priority Data
Oct. 18, 2023 (JP) 2023-179682

(51) Int. Cl. B60L 53/16; B60L 53/30

(52) U.S. Cl. CPC B60L 53/16; B60L 53/305

(57) ABSTRACT

ECU is a control device for a locking mechanism that secures a charging connector to an inlet of a vehicle. ECU includes a CPU and an interface for receiving a signal indicating whether the charging connector is connected to the inlet and whether the charging connector is for direct current or alternating current. CPU determines whether the charging connector connected to the inlet is for AC/DC using the received signal, and unlocks the locking device according to whether the charging connector is for AC or DC. On the other hand, CPU unlocks the locking device according to the condition for AC before determining whether the charging connector is for AC or DC.

### CROSS-REFERENCE TO RELATED APPLICATION

This application claims priority to Japanese Patent Application No. 2023-179682 filed on Oct. 18, 2023, incorporated herein by reference in its entirety.

### BACKGROUND

### 1. Technical Field

The present disclosure relates to a control device for a locking device, and more particularly, to a control device for a locking device that fixes a charging connector of a power supply device to an inlet of a vehicle.

### 2. Description of Related Art

Hitherto, there has been a technology for appropriately controlling a locking mechanism based on a type of a charging connector attached to an inlet of a vehicle (see, for example, Japanese Unexamined Patent Application Publication No. 2023-59944 (JP 2023-59944 A)). In this technology, an electronic control unit (ECU) acquires a pilot signal CPLT and a connector connecting signal PISW, and determines the type of a charging connector when the charging connector is attached. When there is a function corresponding to the type of the attached charging connector, the ECU controls the charging connector into a locked state, and executes control corresponding to the attached charging connector. The ECU maintains an unlocked state of the charging connector when there is no function corresponding to the type of the attached charging connector.

### SUMMARY

FIG. 5 is a timing chart related to connector connection in the related art. Referring to FIG. 5, in the technology of JP 2023-59944 A, the charging connector is controlled into the locked state when the charging connector is connected, and then the type of the charging connector is determined based on the pilot signal CPLT. In a case of AC charging, the charging connector is controlled into the unlocked state when an unlocking operation is performed. In a case of DC charging, the charging connector is not controlled into the unlocked state even when the unlocking operation is performed. However, there is a possibility that the charging connector cannot be brought into the unlocked state regardless of whether the charging is AC charging until the determination of the type of the charging connector is completed.

The present disclosure has been made to solve the above problem. An object of the present disclosure is to provide a control device for a locking device capable of bringing the locking device for a charging connector into an unlocked state even when determination of the type of the charging connector is not completed.

A control device for a locking device according to the present disclosure is a control device for a locking device configured to fix a charging connector of a power supply device to an inlet of a vehicle. The control device includes: a processor; and a reception unit configured to receive a signal from a detection unit configured to output a signal indicating whether the charging connector is connected to the inlet and whether the charging connector is for direct current or alternating current. The processor is configured to: determine whether the charging connector connected to the inlet is for the alternating current or the direct current using the signal received by the reception unit; after determination is made as to whether the charging connector is for the alternating current or the direct current, bring the locking device into an unlocked state under different conditions depending on determination as to which of the alternating current or the direct current the charging connector is for; and bring the locking device into the unlocked state under a condition for the alternating current before determination is made as to whether the charging connector is for the alternating current or the direct current.

With such a configuration, it is possible to provide the control device for the locking device capable of bringing the locking device for the charging connector into the unlocked state even when the determination of the type of the charging connector is not completed.

The processor may be configured to bring the locking device into a locked state when the charging connector is in the unlocked state at a time of determination that the charging connector is for the direct current.

The related-art charging connector for direct current is brought into the locked state when connection check is performed. The locked state is maintained until charging is started. In the above configuration, however, even the charging connector for the direct current may be brought into the unlocked state after the connection check is performed. With such a configuration, the charging connector is brought into the locked state again when determination is made that the charging connector is for the direct current. As a result, charging can be started after the charging connector is brought into the locked state.

The processor may be configured to bring the locking device into a locked state in response to an operation of bringing the locking device into the locked state at a time of determination that the charging connector is for the alternating current.

With such a configuration, in the case where the charging connector is for the alternating current, the locking device can be brought into the locked state in response to the operation of bringing the locking device into the locked state.

According to the present disclosure, it is possible to provide the control device for the locking device capable of bringing the locking device for the charging connector into the unlocked state even when the determination of the type of the charging connector is not completed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of a configuration of a vehicle;

FIG. 2 is a diagram illustrating an example of a circuit configuration in a power supply facility and a vehicle;

FIG. 3 is a flowchart illustrating a flow of the release condition distribution processing;

FIG. 4 is a timing diagram for connecting connectors for HLC communication; and

FIG. 5 is a timing chart related to a conventional connector connection.

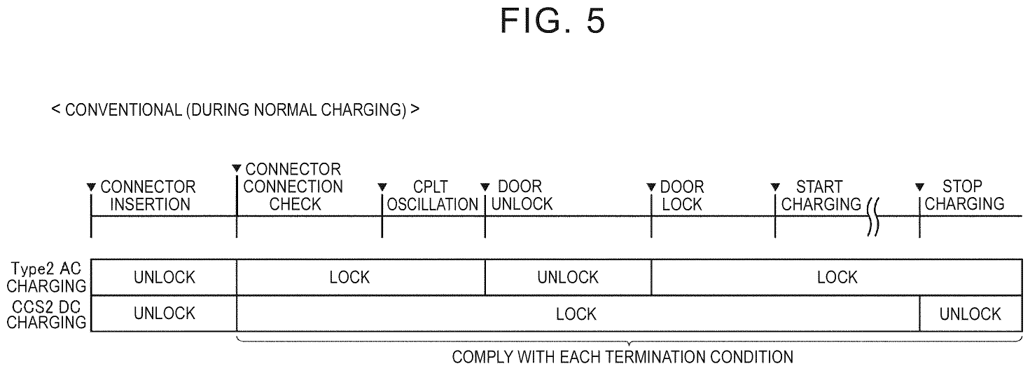

### DETAILED DESCRIPTION OF EMBODIMENTS

Hereinafter, embodiments of the present disclosure will be described in detail with reference to the drawings. It should be noted that the same or corresponding parts in the drawings are designated by the same reference characters and repetitive description will be omitted.

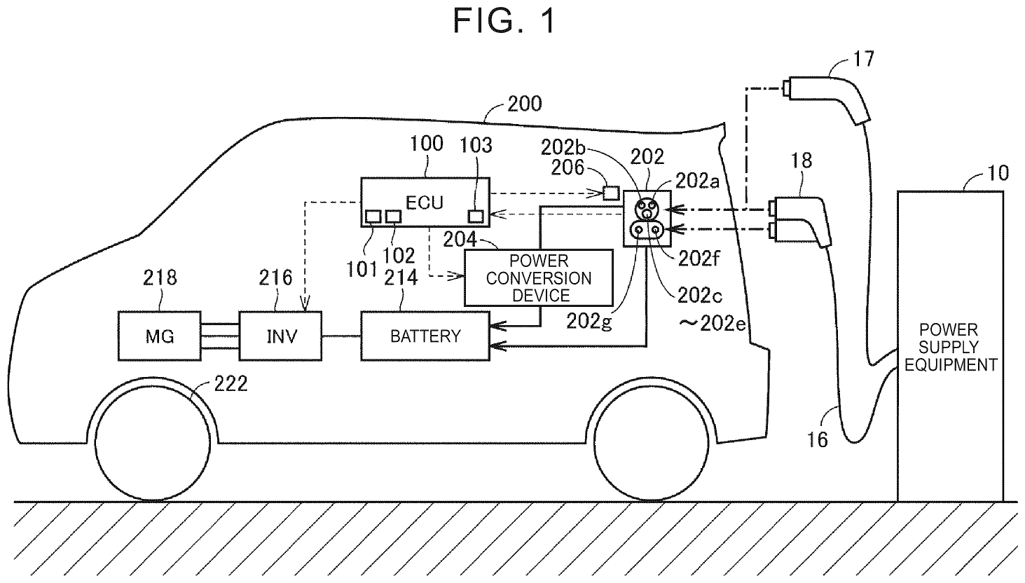

Hereinafter, a configuration of electrified vehicle 200 according to the present embodiment (hereinafter, referred to as a vehicle) will be described. FIG. 1 is a diagram illustrating an example of a configuration of a vehicle 200. The vehicle 200 includes, for example, an electrified vehicle capable of exchanging electric power with electric devices outside the vehicle 200, such as a plug-in hybrid electric vehicle and a battery electric vehicle. In FIG. 1, for example, it is assumed that the vehicle 200 is parked in a parking space in which the power supply facility 10 is installed.

As illustrated in FIG. 1, the vehicle 200 includes an ECU (Electronic Control Unit) 100, an inlet 202, a power conversion device 204, a locking mechanism 206, a battery 214, an inverter 216, and a motor generator (MG) 218.

The motor generator 218 is, for example, a three-phase AC rotating electric machine, and has a function as an electric motor and a function as a generator. That is, the motor generator 218 exchanges electric power with the inverter 216.

For example, when the vehicle 200 is driven, the motor generator 218 applies a rotational force to the drive wheels 222 using electric power supplied from the inverter 216. The drive wheels 222 are rotated by a rotational force applied by the motor generator 218 to drive the vehicle 200. Note that the number of the motor generators 218 is not limited to one, and may be a plurality.

Inverter 216 bi-directionally converts power between motor generator 218 and battery 214 in response to control signals from ECU 100. For example, when the motor generator 218 is driven, the inverter 216 converts the DC power of the battery 214 into AC power and supplies the AC power to the motor generator 218. The inverter 216 converts AC power (regenerative power) generated in the motor generator 218 into DC power and supplies the DC power to the battery 214 when the motor generator 218 generates power, for example. A converter that adjusts the voltage of the inverter 216 and the voltage of the battery 214 may be provided between the inverter 216 and the battery 214.

The battery 214 is, for example, a power storage element configured to be rechargeable, and typically a secondary battery such as a nickel metal hydride battery or a lithium-ion battery having a solid or liquid electrolyte is used. Alternatively, the battery 214 may be any power storage device capable of storing electric power, and for example, a large-capacity capacitor may be used instead of the battery 214.

The battery 214 is externally charged using electric power supplied from the power supply facility 10. External charging includes AC charging and DC charging. AC charging is charging using DC power supplied by converting AC power supplied from an external facility (power supply facility 10) to the inlet 202 in the power conversion device 204. DC charging is charging using DC power supplied from the power supply facility 10 to the inlet 202 without passing through the power conversion device 204.

The inlet 202 is provided on an exterior portion of the vehicle 200 together 10 with a cover (not shown) such as a lid, and is configured to be attachable to various connectors to be described later. The inlet 202 may be supplied with electric power used for charging the battery 214 from an external facility.

The inlet 202 has a configuration that can be attached to both the charging connector 17 used for AC charging and the charging connector 18 used for DC charging. 15 The inlet 202 is provided with AC connecting portions 202a, 202b, DC connecting portions 202f, 202g, and a 202e from the communication unit 202c.

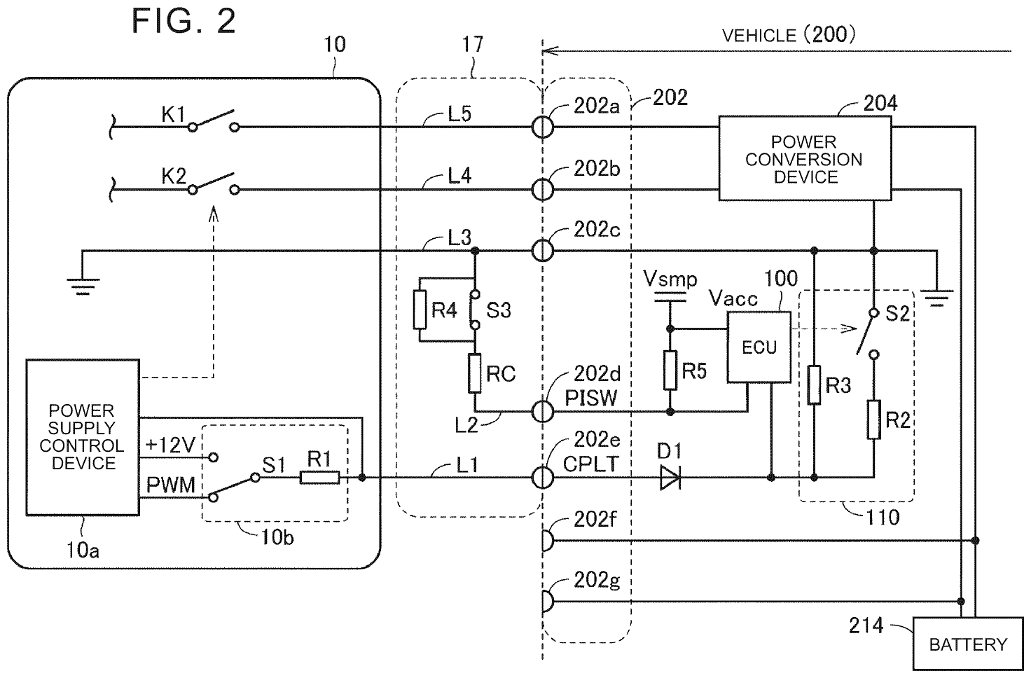

When the charging connector 17 for AC of the power supply facility 10 is attached to the inlet 202, AC connecting portion (see FIG. 2) of the charging connector 17 for AC is electrically connected to AC connecting portions 202a, 202b of the inlet 202. In addition, a communication unit (see FIG. 2) of the charging connector 17 for AC is connected to 202e from the communication unit 202c of the inlet 202.

When the charging connector 18 for DC of the power supply facility 10 is attached to the inlet 202, AC connecting portion (not shown) of the charging connector 18 for DC is electrically connected to AC connecting portions 202a, 202b of the inlet 202. In addition, a communication unit (not shown) of the charging connector 18 for DC is connected to 202e from the communication unit 202c of the inlet 202.

The power conversion device 204 performs power conversion between the battery 214 and the inlet 202 in response to a control signal from ECU 100. For example, when AC charging is performed on the battery 214 with the charging connector 17 for AC attached to the inlet 202, the power conversion device 204 converts AC power supplied from the charging connector 17 for AC into DC power. The battery 214 is charged using the converted DC power.

The locking mechanism 206 restricts the removal of the connector attached to the inlet 202 so as to be fixed to the inlet 202 (locked state). The locking mechanism 206 releases the restriction on the detachment of the connector to allow the connector to be detached from the inlet 202 (unlocked state). The locking mechanism 206 is provided with an actuator. The actuator, for example, moves the member to a position that restricts movement of the connector attached to the inlet 202 to a locked state. The actuator, for example, moves the member to a position permitting movement of the connector in a state of being attached to the inlet 202 so as to be in an unlocked state. That is, the locking mechanism 206 switches from one of the locked state and the unlocked state to the other state in response to a control signal from ECU 100.

ECU 100 includes a CPU (Central Processing Unit) 101, a memory (e.g., ROM (Read Only Memory), RAM (Random Access Memory), and the like) 102, and an interface 103. ECU 100 controls each device (e.g., the power conversion device 204, the locking mechanism 206, or the inverter 216) by outputting a signal from the interface 103 so that the vehicle 200 is in a desired condition based on information such as a map and a program stored in the memory 102 and information from various sensors received by the interface 103. Note that various kinds of control performed by ECU 100 are not limited to processing by software, and dedicated hardware (electronic circuitry) can be constructed and processed.

Further, when the connector (the charging connector 17 for AC and the charging connector 18 for DC) is attached to the inlet 202, ECU 100 executes a communication process of receiving predetermined data from the connector-side device (the power supply facility 10) at the interface 103. The predetermined information includes, for example, information on power that can be exchanged between the power supply facility 10 and the battery 214 (such as a connector-connection-signal PISW described later).

For example, when the charging connector 17 for AC is attached to the inlet 202, ECU 100 receives predetermined data from the power supply facility 10 (more specifically, the charging connector 17 for AC) at the interface 103. The predetermined information includes information indicating that the communication unit of the charging connector 17 for AC and the communication unit 202c, 202d and 202e of the inlet 202 are connected, and the electric power transmitted and received between the charging connector 17 for AC and the inlet 202 is AC power, and information indicating that the electric power transmitted and received between the charging connector 17 for AC and the inlet 202 is the charging power for charging the battery 214.

Alternatively, ECU 100 receives predetermined data from the power supply facility 10 (more specifically, the charging connector 18 for DC) at the interface 103 when the charging connector 18 for DC is attached to the inlet 202, for example. The predetermined information includes information indicating that the communication unit of the charging connector 18 for DC and the communication unit 202c, 202d and 202f of the inlet 202 are connected, and the electric power exchanged between the charging connector 18 for DC attached from the power supply facility 10 and the inlet 202 is DC power, and information indicating that the electric power exchanged between the charging connector 18 for DC and the inlet 202 is charging power.

When the charging connector 17 for AC of the power supply facility 10 is attached to the inlet 202 of the vehicle 200, the power supply facility 10 supplies AC power to the inlet 202. The AC power supplied to the inlet 202 is converted into DC power by the power conversion device 204. The converted DC power is supplied to the battery 214, and the battery 214 is charged.

When the charging connector 18 for DC of the power supply facility 10 is attached to the inlet 202 of the vehicle 200, the power supply facility 10 supplies DC power to the inlet 202. The DC power supplied to the inlet 202 is supplied to the battery 214 without passing through the power conversion device 204, and the battery 214 is charged.

Hereinafter, referring to FIG. 2, a circuit configuration of the power supply facility 10 and the vehicle 200 will be described as an example in which the charging connector 17 for AC is attached to the inlet 202. FIG. 2 is a diagram illustrating an example of a circuit configuration of the power supply facility 10 and the vehicle 200.

The power supply facility 10 includes power supply-relays K1, K2, a power supply control device 10a, and an oscillation circuit 10b. When the power supply-relays K1, K2 are open, the power supply path is interrupted. In addition, when the power supply-relays K1, K2 are in the closed state, power can be supplied from the AC power supply of the power supply facility 10 to the vehicle 200 via the charging connector 17 and the inlet 202 for AC.

The oscillation circuit 10b provides a pilot-signal CPLT to ECU 100 via AC charging connector 17 and inlet 202. The electric potential of the pilot signal CPLT is controlled by ECU 100, and is used as a signal for remotely controlling the power supply relays K1, K2 from ECU 100.

The power supply control device 10a controls the power supply relays K1, K2 based on the potential of the pilot-signal CPLT. The pilot signal CPLT is used as a signal for notifying the ECU 100 of the rated current at the time of AC charge from the oscillation circuit 10b.

The power supply control device 10a includes a CPU, a memory, and the like. The power supply control device 10a detects the potential of the pilot signal CPLT outputted from the oscillation circuit 10b, and controls the operation of the oscillation circuit 10b based on the detected potential of the pilot signal CPLT.

The power supply control device 10a controls the operation of the oscillation circuit 10b such that when the connector is not connected to the inlet 202, the battery is V0 (e.g., +12 V) and the non-oscillating pilot-signal CPLT is outputted.

Specifically, the oscillation circuit 10b includes, for example, a switch S1 and a resistor R1. One end of the resistor R1 is connected to the switch S1. The other end of the resistor R1 is connected to one end of the signal line L1. The other end of the signal-line L1 is electrically connected to the communication unit 202e when AC charging connector 17 is attached to the inlet 202. The switch S1 is configured to conduct either one of the power supply of the power supply control device 10a in the positive 12V and the oscillating device of the power supply control device 10a and the resistor R1. When the connector is not connected to the inlet 202, the power supply control device 10a controls the switch S1 so that the power supply of the positive 12V and the resistor R1 become conductive. Therefore, the oscillation circuit 10b outputs a pilot signal CPLT having a potential of +12V and non-oscillation to the signal line L1.

The power supply control device 10a controls the operation of the oscillation circuit 10b such that, when the connector is connected to the inlet 202, the pilot-signal CPLT oscillating at a predetermined frequency and duty cycle is outputted.

Specifically, for example, when the charging connector 17 for AC is connected, the resistor R1 and the resistor R3 (described later) of the vehicle 200 become conductive, and the potential of the pilot-signal CPLT decreases to a V1 lower than that of V0. Therefore, the power supply control device 10a controls the switch S1 so that the oscillator device and the resistor R1 become conductive. Therefore, the oscillation circuit 10b outputs, to the signal line L1, a pilot signal CPLT whose upper limit of the potential is V1 and oscillates at a predetermined frequency and duty cycle.

The duty cycle of the pilot-signal CPLT is set in advance according to the rated current. ECU 100 can acquire the rated current of the power supply facility 10 by using the duty cycle of the pilot-signal CPLT received by the interface 103 through the communication unit 202e.

When the upper limit of the potential of the pilot-signal CPLT decreases to V2 (<V1), the power supply control device 10a controls the power supply-relays K1, K2 so as to be closed. As a result, electric power from the AC power supply is supplied to the inlet 202 through AC charging connector 17. The upper limit of the potential of the pilot-signal CPLT is lowered to V2, for example, when the switch S2 (described later) becomes conductive.

The charging connector 17 for AC includes resistors R4, RC and a switch S3. One end of the switch S3 is connected to the grounding line L3. The other end of the switch S3 is connected to one end of the resistor RC. The resistor R4 is connected in parallel to the switch S3. The other end of the resistor RC is connected to the signal line L2. The signal line L2 is electrically connected to the communication unit 202d when the charging connector 17 for AC is attached to the inlet 202.

The switch S3 is interlocked with a push-button provided in the charging connector 17 for AC. When the push-button is not pressed, the switch S3 is closed. When the push button is pressed, the switch S3 is opened.

One end of the resistor R5 is connected to the communication unit 202d, and the other end of the resistor R5 is connected to the power supply Vsmp. ECU 100 is configured to be capable of acquiring a potential between the resistor R5 and the communication unit 202d. The resistors RC, R4, R5, the switch S3, and the power supply Vsmp constitute a connection detector for detecting a connection between the charging connector 17 for AC and the inlet 202.

When the charging connector 17 for AC is attached to the inlet 202, a signal having a potential (V3) determined by the voltage of the power supply Vsmp and the resistance of the resistor R5 is generated as the connector connecting signal PISW on the signal line L2.

When the charging connector 17 for AC is attached to the inlet 202 and the push-button is in a non-operating state, a signal having a potential (V4) determined by the voltage of the power supply Vsmp and the resistors R5, RC is generated as the connector connecting signal PISW on the signal line L2.

When the push-button is operated while the charging connector 17 for AC is attached to the inlet 202, a signal having a potential (V5) determined by the voltage of the power supply Vsmp and the resistors R4, R5, RC is generated as the connector connecting signal PISW on the signal line L2.

Therefore, ECU 100 can detect the connection status between the charging connector 17 for AC and the inlet 202 by acquiring the potential of the connector connection signal PISW. In addition, at least the resistor RC differs between the charging connector 17 for AC and the charging connector 18 for DC. Therefore, ECU 100 can acquire the type of the connector connected by the potential of the connector connection signal PISW when the connector is connected to the inlet 202.

The vehicle 200 further includes a resistance circuit 110. The resistance circuit 110 is a circuit for operating the potential of the pilot signal CPLT generated on the signal line L1. The resistance circuit 110 includes resistors R2, R3 and a switch S2.

One end of the resistor R2 is connected to the grounding line L3 via the switch S2. The other end of the resistor R2 is connected to a signal line L1 on which the pilot signal CPLT is generated. The resistor R3 is connected between the signal-line L1 and the grounding line L3. That is, one end of the resistor R3 is connected to the grounding line L3. The other end of the resistor R3 is connected to the signal line L1. The switch S2 is turned on/off in response to a control signal from ECU 100.

When the charging connector 17 for AC is attached to the inlet 202 and the switch S2 is in the off-state (cut-off state), the potential of the pilot-signal CPLT becomes a potential V1 determined by the resistors R1, R3. When AC charging connector 17 is attached to the inlet 202 and the switch S2 is turned on (conductive), the potential of the pilot-signal CPLT becomes a potential V2 determined by the resistors R1, R2, R3.

When AC charging connector 17 is attached to the inlet 202, ECU 100 switches the switch S2 on/off to change the potential of the pilot-signal CPLT, thereby requesting the power supply facility 10 to supply power and stop the power supply.

Specifically, ECU 100 requests power supply to the power supply facility 10 by, for example, turning on the switch S2 and changing the potential of the pilot-signal CPLT from V1 to V2. In addition, ECU 100 requests the power supply facility 10 to stop power supply, for example, by turning off the switch S2 and changing the potential of the pilot-signal CPLT from V2 to V1.

When the power supply control device 10a closes the power supply relays K1, K2 by turning on the switch S2, AC power is supplied from the power supply facility 10 to the power conversion device 204 through the inlet 202. After completion of the predetermined charge preparation process, ECU 100 operates the power conversion device 204 to convert AC power into DC power and charge the battery 214.

Conventionally, as described above, when the charging connector 17 for AC or the charging connector 18 for DC is connected, it is controlled to be locked, and then the type of the charging connector is determined by the pilot-signal CPLT. In the case of AC charging, when the unlocking operation is performed, the charging connector 17 is controlled to be in the unlocked state, and when the charging is DC, even if the unlocking operation is performed, the charging connector 18 is not controlled to be in the unlocked state. However, until the determination of the type of the charging connector is completed, there is a possibility that the charging connector cannot be unlocked regardless of whether the charging connector is AC or not.

Therefore, ECU 100 determines whether the charging connector connected to the inlet is for AC or DC using the signal received by the reception unit. ECU 100, after the charging connector is determined to be one of AC and DC, unlocks the locking mechanism 206 according to a different criterion based on whether it is determined to be one of AC and DC. On the other hand, ECU 100 unlocks the locking mechanism 206 in accordance with the AC condition prior to determining whether the charging connector is for AC or DC.

Thus, even when the determination of the type of the charging connector is not completed, the locking mechanism 206 of the charging connector can be brought into the unlocked state.

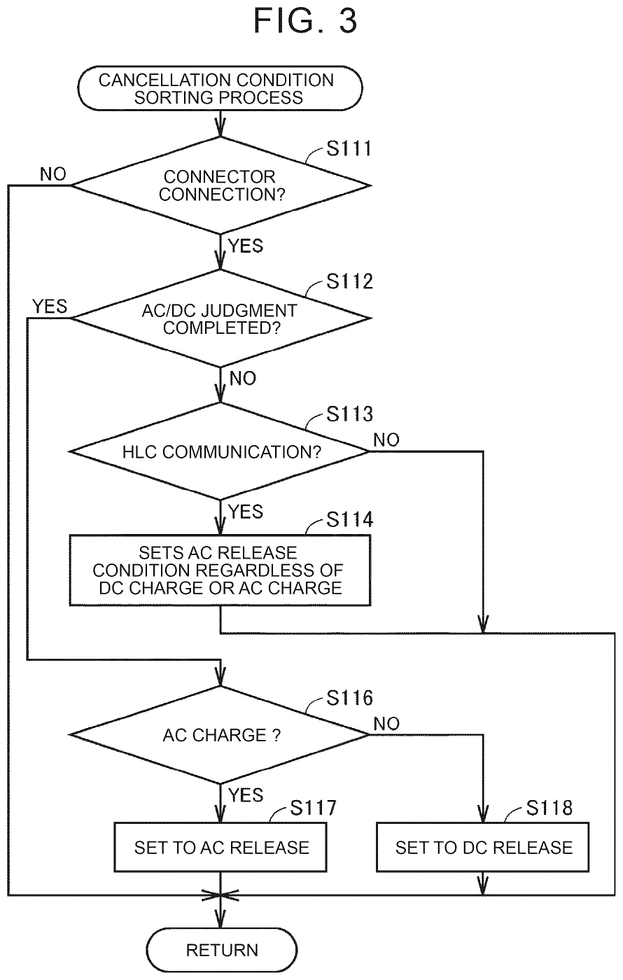

FIG. 3 is a flowchart illustrating a flow of a cancellation condition sorting process. Referring to FIG. 3, this process is called and executed by CPU 101 of ECU 100 at every predetermined cycle from the higher-order process.

CPU 101 determines whether the charging connector is connected to the inlet 202 (S111). If it is determined that there is no connection (NO in S111), CPU 101 returns the processing to be executed to the higher-level processing. On the other hand, when it is determined that the charging connector is connected (YES in S111), CPU 101 determines whether the determination as to whether the charging connector is for AC or DC is completed (S112).

When it is determined that the determination for/DC for AC is not completed (NO in S112), CPU 101 determines whether or not communication with the power supply facility 10 is performed by HLC (High Level Communication) communication (S113). HLC communication is a communication corresponding to an ISO 15118, and is a digital communication that exchanges information bidirectionally between the vehicle 200 and the power supply facility 10. The signal of HLC communication is superimposed on the pilot-signal CPLT between ECU 100 and the power supply control device 10a and transmitted and received.

In HLC communication, determination for/DC for AC may be time-consuming due to some factor. If it is determined that HLC communication is performed (YES in S113), CPU 101 sets the release condition for unlocking the locking mechanism 206 to the release condition for AC regardless of DC charge and AC charge (S114). On the other hand, when it is determined that HLC communication is not performed (NO in S113), or after S114, CPU 101 returns the processing to be executed to the higher-level processing. In this instance, since the communication is not HLC communication, it is determined that the determination for AC/DC use is immediately ended and the determination for AC/DC use is completed in S112 of the subsequent run cycle.

When it is determined that the determination for AC use/DC is completed (YES in S112), CPU 101 determines whether or not it is determined to be AC charged (S116). When it is determined that AC charge has been determined (YES in S116), CPU 101 sets the release condition to the release condition for AC (S117). On the other hand, when it is determined that the charge is not AC, that is, the charge is DC (NO in S116), CPU 101 sets the release condition to the release condition for DC (S118). After S117 or S118, CPU 101 returns the processing to be executed to the higher-level processing.

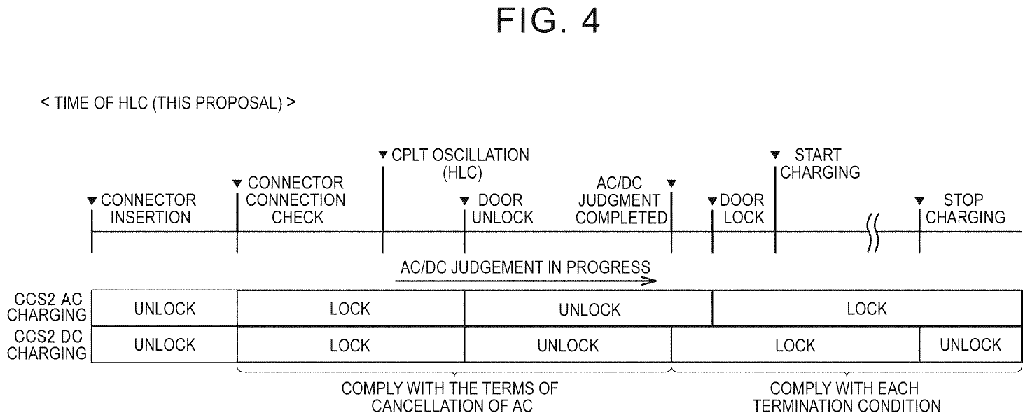

FIG. 4 is a timing chart for connecting connectors for HLC communication. Referring to FIG. 4, the charging connector is unlocked in accordance with an AC release condition (for example, a condition that a door unlock operation has been performed) irrespective of the AC/DC charge, until the determination for AC/DC is completed. After the determination for AC/DC is completed, for the AC charge, the charging connector 17 for AC is brought into a locked state in response to a lock operation (door lock operation in the drawing), and is brought into an unlocked state in accordance with a release condition for AC. On the other hand, in the case of DC charging, the charging connector 18 for DC is brought into a locked state upon completion of the determination, and is then brought into an unlocked state in accordance with a release condition for DC (for example, a condition that charging is stopped).

### Modifications

(1) In the above-described embodiment, in S113 of FIG. 3, it is determined whether communication with the power supply facility 10 is performed by HLC communication. However, the present disclosure is not limited to HLC communication, and other communication methods may be used as long as it takes a long time to determine whether the charging connector is for AC or DC as compared with the pilot-signal CPLT.

(2) In the above-described embodiment, as shown in the drawing of the inlet 202 of FIG. 1, the type of the connector is CCS (Combined Charging System). However, the type of the connector is not limited to this, and other types may be used as long as the type is a combination of AC and DC.

(3) The above-described disclosure can be regarded as a disclosure of a control device such as the vehicle 200 or an ECU 100, or a disclosure of a control method or a control program executed by the control device. Summary

(1) As illustrated in FIGS. 1 to 3, ECU 100 is a control device for a locking mechanism 206 that fixes the charging connectors 17 and 18 of the power supply facility 10 to the inlet 202 of the vehicle 200. As illustrated in FIGS. 1 and 2, ECU 100 includes a CPU 101, and an interface 103 that receives a signal from a detection unit (the circuitry illustrated in FIG. 2) that outputs a signal indicating whether or not the charging connectors 17 and 18 are connected to the inlet 202 and whether or not the charging connectors are for DC or AC. As shown in FIGS. 3 and 4, CPU 101 uses the received signal at interface 103 to determine (e.g., S112) whether the charging connector connected to inlet 202 is AC or DC. After it is determined whether the charging connector is for AC or DC, CPU 101 unlocks the locking device according to a different criterion depending on whether the charging connector is for AC or DC (e.g., from S116 to S118). On the other hand, prior to determining whether the charging connector is for AC or DC, CPU 101 unlocks the locking device according to the AC requirements (e.g., S113, S114).

Thus, even when the determination of the type of the charging connector is not completed, the locking mechanism 206 of the charging connector can be brought into the unlocked state.

(2) As shown in FIG. 4, CPU 101 may place the locking device in a locked state when the charging connector 18 is in an unlocked state when it is determined that the charging connector is for direct current.

Accordingly, when it is determined that the charging connector is for DC, the charging connector is locked again. As a result, charging can be started after the charging connector is locked.

(3) As illustrated in FIG. 4, CPU 101 may set the locking mechanism 206 to the locked state in response to an operation of setting the locking mechanism 206 to the locked state when it is determined that the charging connector is for AC.

Thus, in the case where the charging connector is for AC, the locking mechanism 206 can be brought into the locked state in accordance with the operation of bringing the charging connector into the locked state.

The embodiment disclosed herein should be considered as illustrative and not restrictive in all respects. It is intended that the scope of the disclosure be defined by the appended claims rather than the description of the embodiments described above, and that all changes within the meaning and range of equivalency of the claims be embraced therein.

What is claimed is:

1. A control device for a locking device configured to fix a charging connector of a power supply device to an inlet of a vehicle, the control device comprising:
a processor; and
a reception unit configured to receive a signal from a detection unit configured to output a signal indicating whether the charging connector is connected to the inlet and whether the charging connector is for direct current or alternating current, wherein the processor is configured to:
determine whether the charging connector connected to the inlet is for the alternating current or the direct current using the signal received by the reception unit;
after determination is made as to whether the charging connector is for the alternating current or the direct current, bring the locking device into an unlocked state under different conditions depending on determination as to which of the alternating current or the direct current the charging connector is for; and
bring the locking device into the unlocked state under a condition for the alternating current before determination is made as to whether the charging connector is for the alternating current or the direct current.

2. The control device for the locking device according to claim 1, wherein the processor is configured to bring the locking device into a locked state when the charging connector is in the unlocked state at a time of determination that the charging connector is for the direct current.

3. The control device for the locking device according to claim 1, wherein the processor is configured to bring the locking device into a locked state in response to an operation of bringing the locking device into the locked state at a time of determination that the charging connector is for the alternating current.
